(19) United States
(12) Patent Application Publication
(10) Pub. No.: US 2022/0342262 A1
(43) Pub. Date: Oct. 27, 2022

(54) DISPLAY PANEL AND DISPLAY DEVICE

(71) Applicant: Xiamen Tianma Micro-Electronics Co., Ltd., Xiamen (CN)

(72) Inventors: Liting FANG, Xiamen (CN); Qiong SONG, Xiamen (CN)

(73) Assignee: Xiamen Tianma Micro-Electronics Co., Ltd., Xiamen (CN)

(21) Appl. No.: 17/422,716

(22) PCT Filed: Jul. 22, 2020
(86) PCT No.: PCT/CN2020/103510

§ 371 Date: Jul. 13, 2021

(30) Foreign Application Priority Data
Jun. 30, 2020 (CN) 202010623333.5

(51) Int. Cl. G02F 1/1343; G02F 1/1333; G02F 1/1335

(52) U.S. Cl. CPC G02F 1/134345; G02F 1/13439; G02F 1/133345; G02F 1/133512; G02F 1/1339

(57) ABSTRACT

Embodiments of the present disclosure provide a display panel and a display device. The display panel includes a first substrate, a second substrate, and a liquid crystal layer. The first substrate includes a base substrate, and data lines and scanning lines that intersect to define sub-pixel units. Each of the sub-pixel units includes a common electrode and a pixel electrode that are arranged in different layers. For each of at least one of the sub-pixel units, the pixel electrode includes at least two strip-shaped electrodes including at least one first strip-shaped electrode and at least one second strip-shaped electrode. The first strip-shaped electrode is insulated from the common electrode, and the second strip-shaped electrode and the common electrode are at a same voltage.

### CROSS-REFERENCE TO RELATED APPLICATIONS

The present disclosure is a National Stage of International Application No. PCT/CN2020/103510, filed on Jul. 22, 2020, which claims priority to Chinese Patent Application No. 202010623333.5, filed on Jun. 30, 2020 and titled “Display Panel and Display Device”, the content of which are incorporated herein by reference in their entireties.

### TECHNICAL FIELD

The present disclosure relates to the field of display technology, and in particular, to a display panel and a display device.

### BACKGROUND

The vehicle-mounted display device as a center console has been widely popularized. The vehicle-mounted display device has the widest temperature range in the current display field. Taking the outdoor use experience into account, in order to ensure that the instrument, navigation and other information can still be displayed normally in a low temperature environment, the vehicle-mounted display device needs to maintain a fast response even in a low temperature environment.

In existing vehicle-mounted display devices, liquid crystal display panels are mainly employed due to considerations of reliability and cost. Due to the characteristics of the liquid crystal itself, the viscosity of the liquid crystals of the existing liquid crystal display panel increases in the low temperature environment, which may result in a long response time and image sticking that affect user experience. In severe cases, information deviation may occur, and result in a potential safety hazard.

In order to shorten response time of the liquid crystal display panel, a solution provided in the prior art is to reduce a cell gap of the liquid crystal display panel and use a low-viscosity liquid crystal material. However, if the cell gap of the liquid crystal display panel is too small, the transmittance and contrast will be reduced, thereby seriously affecting the display effect. Therefore, the cell gap of the liquid crystal display panel maintains greater than 2.8 μm. In addition, the low-viscosity liquid crystal material is suitable for a relatively small temperature range, which cannot meet the usage requirements for the vehicle-mounted display devices.

Therefore, increasing the response speed of the liquid crystal display panel in a low temperature environment is a technical problem which needs to be solved in this technical field.

### SUMMARY

In a first aspect, an embodiment of the present disclosure provides a display panel, and the display panel includes a first substrate, a second substrate opposite to the first substrate, a liquid crystal layer sealed between the first substrate and the second substrate, and an auxiliary electrode. The first substrate includes a base substrate, and data lines and scanning lines that are located on the base substrate. The data lines and the scanning lines intersect to define sub-pixel units, and each of the sub-pixel units includes a common electrode and a pixel electrode that are arranged in different layers. The auxiliary electrode is located between two adjacent sub-pixel units of the sub-pixel units, and the auxiliary electrode and the common electrode have a same voltage. For each of at least one of the sub-pixel units, the pixel electrode includes at least two strip-shaped electrodes, and the at least two strip-shaped electrodes include at least one first strip-shaped electrode and at least one second strip-shaped electrode. The at least one first strip-shaped electrode is insulated from the common electrode, and the at least one second strip-shaped electrode and the common electrode have a same voltage.

In another aspect, an embodiment of the present disclosure provides a display device including a display panel. The display panel includes a first substrate, a second substrate opposite to the first substrate, a liquid crystal layer sealed between the first substrate and the second substrate, and an auxiliary electrode. The first substrate includes a base substrate, and data lines and scanning lines that are located on the base substrate. The data lines and the scanning lines intersect to define sub-pixel units, and each of the sub-pixel units includes a common electrode and a pixel electrode that are arranged in different layers. The auxiliary electrode is located between two adjacent sub-pixel units of the sub-pixel units, and the auxiliary electrode and the common electrode have a same voltage. For each of at least one of the sub-pixel units, the pixel electrode includes at least two strip-shaped electrodes, and the at least two strip-shaped electrodes include at least one first strip-shaped electrode and at least one second strip-shaped electrode. The at least one first strip-shaped electrode is insulated from the common electrode, and the at least one second strip-shaped electrode and the common electrode have a same voltage.

### BRIEF DESCRIPTION OF DRAWINGS

In order to more clearly illustrate technical solutions in embodiments of the present disclosure, the accompanying drawings used in the embodiments are briefly introduced as follows. It should be noted that the drawings described as follows are merely some of the embodiments of the present disclosure, and other drawings can also be obtained by those skilled in the art.

FIG. 1 is a schematic diagram of a display panel according to an embodiment of the present disclosure;

FIG. 2 is a cross-sectional view along BB′ shown in FIG. 1;

FIG. 3 is a schematic diagram of another display panel according to an embodiment of the present disclosure;

FIG. 4 is a cross-sectional view along CC′ shown in FIG. 3;

FIG. 5 is a schematic diagram of still another display panel according to an embodiment of the present disclosure;

FIG. 6 is a cross-sectional view along DD′ shown in FIG. 5;

FIG. 7 is a cross-sectional view of still another display panel according to an embodiment of the present disclosure;

FIG. 8 is a cross-sectional view of still another display panel according to an embodiment of the present disclosure;

FIG. 9 is a cross-sectional view of still another display panel according to an embodiment of the present disclosure; and

FIG. 10 is a schematic diagram of a display device according to an embodiment of the present disclosure.

### DESCRIPTION OF EMBODIMENTS

For better illustrating technical solutions of the present disclosure, embodiments of the present disclosure will be described in the following in detail with reference to the accompanying drawings.

It should be noted that, the described embodiments are merely some embodiments of the present disclosure, but not all the embodiments. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a/an”, “the” and “said” used in the embodiments and appended claims of the present disclosure are also intended to represent plural form expressions thereof.

It should be understood that the term “and/or” used herein is merely an association relationship describing associated objects, indicating that there can be three relationships, for example, A and/or B can indicate that three cases, i.e., A alone, A and B, B alone. In addition, the character “/” herein generally indicates that the related objects before and after the character are in an “or” relationship.

In the description of this specification, it should be understood that the terms “substantially”, “basically” “approximately”, “about”, “almost” and “roughly” described in the claims and embodiments of the present disclosure indicates a value that can be generally agreed within a reasonable process operation range or a tolerance range, rather than an exact value.

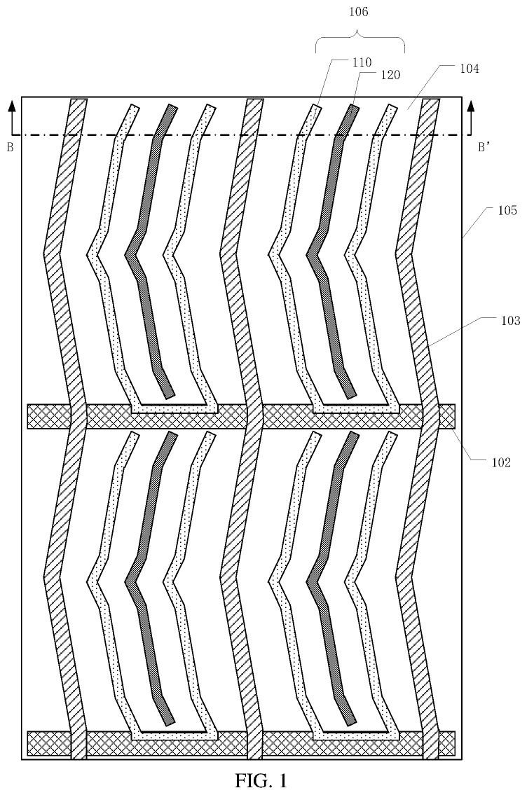

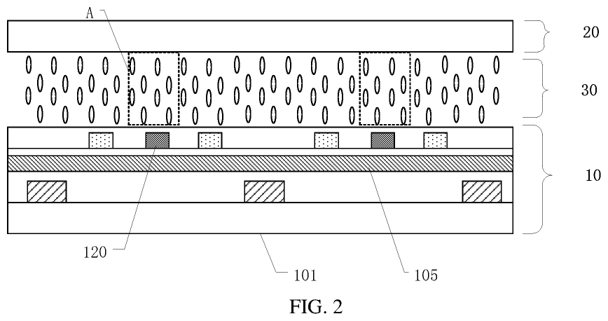

Referring to FIG. 1 and FIG. 2, FIG. 1 is a schematic diagram of a display panel according to an embodiment of the present disclosure, and FIG. 2 is a cross-sectional view along BB′ shown in FIG. 1.

An embodiment provides a display panel, and the display panel includes a first substrate 10, a second substrate 20 opposite to the first substrate 10, and a liquid crystal layer 30 sealed between the first substrate 10 and the second substrate 20.

The first substrate 10 includes a base substrate 101, and a plurality of data lines 102 and a plurality of scanning lines 103 that are provided on the base substrate 101, the plurality of data lines 102 intersects the plurality of scanning lines 103 to define a plurality of sub-pixel units 104, and the sub-pixel unit 104 includes a common electrode 105 and a pixel electrode 106 that are arranged at different layers.

In each of at least one sub-pixel unit 104, the pixel electrode 106 includes at least two strip-shaped electrodes, and the at least two strip-shaped electrodes include at least one first strip-shaped electrode 110 and at least one second strip-shaped electrode 120. The first strip-shaped electrode 110 and the common electrode 105 are insulated from each other, and the second strip-shaped electrode 120 and the common electrode 105 have a same voltage.

The display panel provided in an embodiment is a liquid crystal display panel, and the liquid crystal layer 30 can be sealed between the first substrate 10 and the second substrate 20 using a sealant.

The first substrate 10 includes a base substrate 101. The base substrate 101 can be rigid, for example, being made of glass material; or the base substrate 101 can be flexible, for example, being made of resin material, which will not be specifically limited in the embodiment.

The plurality of data lines 102 and the plurality of scanning lines 103 that are insulated from and cross each other are provided on the base substrate 101, and the plurality of data lines 102 and the plurality of scanning lines 103 define the sub-pixel units 104. The sub-pixel unit 104 includes the common electrode 105 and the pixel electrode 106 that are arranged in different layers. It should be noted that the common electrode 105 can cover only one sub-pixel unit 104, or can cover two or more sub-pixel units 104. The common electrode 105 can be strip-shaped, block-shaped, or designed into an entire surface, which will not be limited herein in the embodiment. The pixel electrodes 106 can correspond to the sub-pixel units 104 in one-to-one correspondence, which will not be limited herein by this embodiment.

Among the plurality of sub-pixel units 104, at least one sub-pixel unit 104 includes the pixel electrode 106 including at least two strip-shaped electrodes, an overall extending direction of the strip-shaped electrode can be substantially the same as an extending direction of the data line 102, and at least two strip-shaped electrodes can be arranged along a direction the same as an extending direction of the scanning line 103. The at least two strip-shaped electrodes include at least one first strip-shaped electrode 110 and at least one second strip-shaped electrode 120. The first strip-shaped electrode 110 and the second strip-shaped electrode 120 have a same shape and a same size, which will not be limited herein by the embodiment.

The first strip-shaped electrode 110 is insulated from the common electrode 105, and during the operation of the display panel, the voltages of the two are different. An electric field formed between the first strip-shaped electrode 110 and the common electrode 105 can control liquid crystal molecules in the liquid crystal layer 30 to be deflected, thereby achieving the display function.

The voltage of the second strip-shaped electrode 120 is the same as the voltage of the common electrode 105, and thus there is no voltage difference therebetween. Therefore, an electric field for controlling deflection of the liquid crystal molecules will not be formed. The liquid crystal molecules in the liquid crystal layer 30 within a region A corresponding to the second strip-shaped electrode 120 will not be deflected, thereby forming the “virtual wall” structure. The liquid crystal molecules within a region corresponding to the first strip-shaped electrode 110 will be deflected during the display process of the display panel. The liquid crystal molecules within the region A can help the deflected liquid crystal molecules to recover to an initial state, thereby increasing the response speed of the display panel. In this way, the display panel will also have a good performance in the low temperature environment.

In addition, in a fabricating process of the liquid crystals, it is inevitable that movable impurity ions will remain in the liquid crystals. When an electric field is supplied to the liquid crystals, the impurity ions will be attracted by charges, having opposite polarity to the impurity ions, on the electrode and move toward the electrode. If a voltage of a same polarity (that is, a direct current (DC) bias voltage) continues to remain on the electrode of an array substrate, for example, when a positive alternating current voltage and a negative alternating current voltage are applied to the pixel electrode, a positive bias voltage will be formed if the positive voltage is higher than the negative voltage, and the bias voltage will attract impurity ions in the liquid crystal panel to form an internal electric field. The electric field will cause the liquid crystal molecules to fail to recover to the initial position at a desired speed, thereby affecting arrangement and penetration of the liquid crystals, and changing T-V (temperature-voltage) curve of the liquid crystals, so that even when no voltage is applied, the arrangement of the liquid crystal will be different from the original arrangement state, resulting in that an image which is supposed to disappear still remains on the liquid crystal display panel, causing image sticking, and affecting the performance of the liquid crystal display panel.

In the display panel provided by the embodiment, the voltage of the second strip-shaped electrode 120 is the same as the voltage of the common electrode 105, that is, the voltage of the second strip-shaped electrode 120 is constant, therefore, charge accumulation in the display panel during the operation process can be reduced, thereby alleviating image sticking. The display panel provided by the embodiment of the present disclosure can improve the user experience, and reliability and safety of the vehicle-mounted display device.

In some embodiments, the number of first strip-shaped electrodes 110 is greater than the number of second strip-shaped electrodes 120. For example, in the display panel shown in FIG. 1 and FIG. 2, there are two first strip-shaped electrodes 110 and one second strip-shaped electrode 120. The second strip-shaped electrode 120 can form the “virtual wall” structure in the liquid crystal layer 30 to prevent the liquid crystal molecules from being deflected, that is, the region where the “virtual wall” is located does not have a display function. Therefore, the number of the second strip-shaped electrodes 120 should not be too large, so as to make the display panel still have a better display effect and a higher transmittance, thereby ensuring the display quality of the display panel and satisfying the user experience.

In some embodiments, two second strip-shaped electrodes 120 are located between two first strip-shaped electrodes 110. For example, referring to the display panel shown in FIG. 1 and FIG. 2, in the liquid crystal layer 30, the liquid crystal molecules at two sides of the “virtual wall” can be deflected to achieve the display function. The “virtual wall” can help the liquid crystal molecules at two sides to recover to the initial state, thereby increasing the response speed of the display panel, enabling the display panel to still have a good performance in the low temperature environment, thus improving the user experience, and reliability and safety of the vehicle-mounted display device.

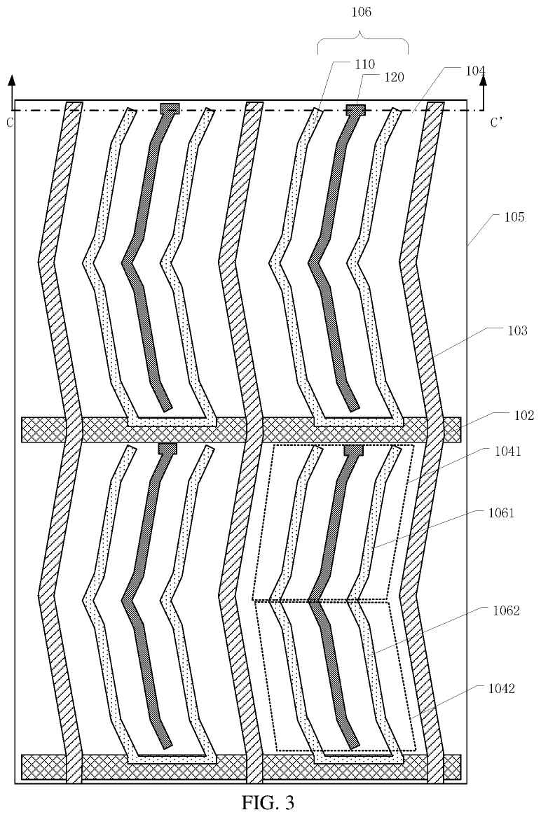

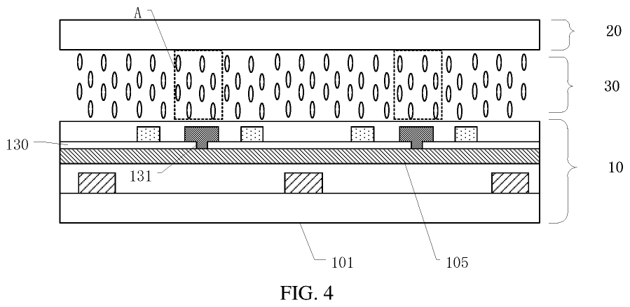

Referring to FIG. 3 and FIG. 4, FIG. 3 is a schematic diagram of another display panel according to an embodiment of the present disclosure, and FIG. 4 is a cross-sectional view along CC′ shown in FIG. 3.

In some embodiments, an insulating layer 130 is provided between the pixel electrode 106 and the common electrode 105, the insulating layer 130 is provided with a first via 131, and the second strip-shaped electrode 120 is electrically connected to the common electrode 105 through the first via 131.

In a process of fabricating the display panel provided in an embodiment, the first via 131 can be formed in the insulating layer 130 using an etching process, and the first via 131 penetrates through the insulating layer 130 and corresponds to the common electrode 105 and the second strip-shaped electrode 120. In the pixel electrode 106 fabricated later, the second strip-shaped electrode 120 is connected to the common electrode 105 via the first via 131, so that the second strip-shaped electrode 120 and the common electrode 105 can always maintain a same voltage, and there is no need to additionally provide an electrical signal to the second strip-shaped electrode 120, thereby simplifying the signal of the display panel.

In the display panel provided in an embodiment of the present disclosure, the sub-pixel unit can be a single-domain structure or a dual-domain structure. Hereinafter, the technical scheme of the present disclosure will be described by taking the sub-pixel unit being a dual-domain structure as an example.

With further reference to FIG. 3, in some embodiments of the present disclosure, the sub-pixel unit 104 is a dual-domain structure, and the dual-domain structure includes a first domain region 1041 and a second domain region 1042.

The strip-shaped electrode includes a first sub-portion 1061 located in the first domain region 1041 and a second sub-portion 1062 located in the second domain region 1042.

The first sub-portions 1061 in the first domain region 1041 are parallel to each other, second sub-portions 1062 in the second domain region 1042 are parallel to each other, and an extending direction of the first sub-portion 1061 intersects an extending direction of the second sub-portion 1062.

The dual-domain structure of the sub-pixel unit is briefly described as follows. The viewing angles of the liquid crystal display panel have a disadvantage of anisotropy, and this is due to the fact that the liquid crystal molecule is approximately cylindrical and has a long axis and a short axis, the deflection directions of the liquid crystal molecules are different, and respective optical path differences of the light passing through the liquid crystal display panel are different. As a result, the viewing angles of the liquid crystal display panel have a character of anisotropy. The principle of the dual-domain structure is that: by configuring the pixel electrode as the dual-domain structure, two types of domain regions are formed in the display panel, namely the first domain region 1041 and the second domain region 1042, and a rotation direction of the liquid crystal molecules in the first domain region 1041 is opposite to a rotation direction of the liquid crystal molecules in a second domain region 1042, and when viewing at different directions of viewing angles, the viewing angle in the first domain region 1041 and the viewing angle in the second domain region 1042 can be complementary, which can solve the horizontal or vertical viewing angle problem. The dual-domain structure can enlarge the view angle of the liquid crystal display panel and alleviate color cast of the display panel.

In the display panel provided in an embodiment, the strip-shaped electrode, as a whole, has a curved shape, similar to a shape of the symbol “<”. The extending directions of some strip-shaped electrodes in the first domain region 1041 are the same or substantially the same. In the display panel shown in FIG. 3, taking the some strip-shaped electrodes in the first domain region 1041 having three sub-sections as an example, the extending directions of the three sub-sections are not exactly the same, but approximately the same. Similarly, the extending directions of some strip-shaped electrode in the second domain region 1042 are the same or approximately the same. In the display panel shown in FIG. 3, the strip-shaped electrode in the second domain region 1042 has three sub-sections, and the extending directions of the three sub-sections are not exactly the same, but approximately the same.

The first sub-portion 1061 and the second sub-portion 1062 can be in mirror symmetry, and the extending directions of the two sub-portions intersect each other.

In the display panel provided in this embodiment, the sub-pixel unit can adopt a dual-domain structure, and the display panel with the dual-domain structure has a higher display quality. While achieving a high display quality, the response speed can be increased.

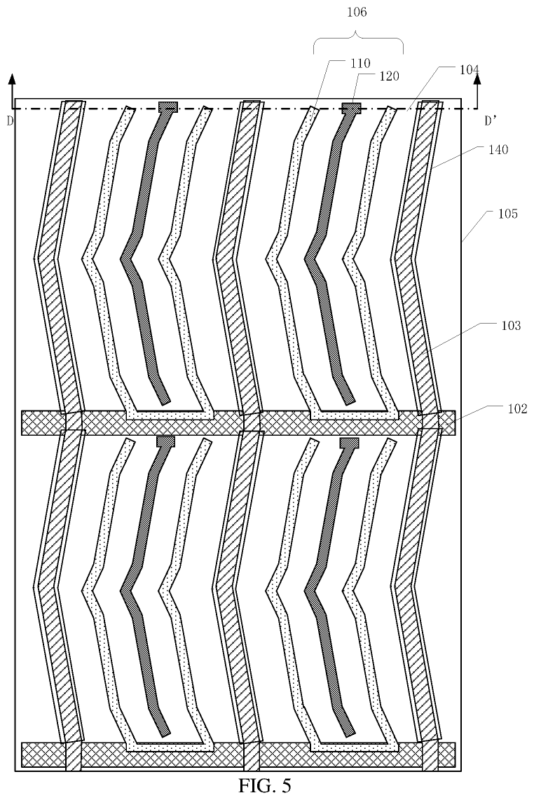

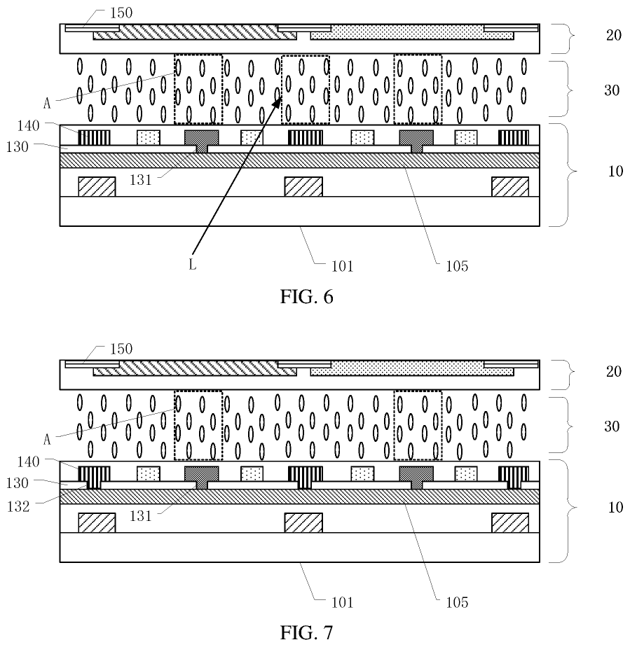

Referring to FIG. 5 and FIG. 6, FIG. 5 is a schematic diagram of still another display panel according to an embodiment of the present disclosure, and FIG. 6 is a cross-sectional view along DD′ shown in FIG. 5.

In some embodiments, the display panel includes an auxiliary electrode 140 located between two adjacent sub-pixel units 104, and a voltage of the auxiliary electrode 140 is the same as the voltage of the common electrode 105.

The display panel provided in this embodiment is provided with the auxiliary electrode 140, and there is no difference between the voltage of the auxiliary electrode 140 and the voltage of the common electrode 105, so an electric field for controlling the liquid crystal molecules to be deflected cannot be formed between the auxiliary electrode 140 and the common electrode 105. That is, the liquid crystal molecules in the liquid crystal layer 30 within a region corresponding to the auxiliary electrode 140 will not be deflected, thereby forming a “virtual wall” structure.

In the embodiment, the liquid crystal molecules between two adjacent sub-pixel units 104 are not deflected. During the operation process of the display panel, the “virtual wall” can prevent light from the sub-pixel unit 104 from exiting from its adjacent sub-pixel unit to cause color mixing. That is, the liquid crystal display panel cannot emit light by itself, a backlight module can be provided to provide a light source, and the “virtual wall” structure can block part of the light L emitted from the backlight module and can prevent the light L from exiting from its adjacent sub-pixel unit to cause color mixing. Therefore, the display panel provided by the embodiment can increase the contrast of the display panel, alleviate the color cast of the display panel, and improve the display quality.

In an embodiment, the auxiliary electrode 140 and the pixel electrode 106 are made of a same material and disposed in a same layer. In the process of fabricating the display panel provided by this embodiment, the auxiliary electrode 140 and the pixel electrode 106 can be fabricated simultaneously using a same material in a same process, which can avoid increasing a film structure of the display panel and avoiding an additional process.

With further reference to FIG. 5 and FIG. 6, in some embodiments, the first substrate 10 or the second substrate 20 is provided with a black matrix 150, and the black matrix 150 is disposed at a side of the pixel electrode 106 facing away from the base substrate 101, and a vertical projection of the auxiliary electrode 140 on the base substrate 101 is located in a vertical projection of the black matrix 150 on the base substrate 101.

In an embodiment, it is described by taking the black matrix 150 being provided at the second substrate 20 as an example. In some other embodiments of the present disclosure, the first substrate 20 is provided with the black matrix 150. The black matrix 150 is located at a side of the pixel electrode 106 facing away from the base substrate 101, so as to block the electrodes, wiring and other structures in the display panel to improve the display quality. The black matrix is usually provided between two adjacent sub-pixel units 104 to block the data line 102. In an embodiment, the auxiliary electrode 140 is arranged under the black matrix 150, and the black matrix 150 can be reused to block the auxiliary electrode to ensure the display quality of the display panel.

Referring to FIG. 7, FIG. 7 is a cross-sectional view of still another display panel according to an embodiment of the present disclosure. In some embodiments, an insulating layer 130 is provided between the pixel electrode 106 and the common electrode 105, and the insulating layer 130 includes a second via 132, via which the auxiliary electrode 140 is electrically connected to the common electrode 105.

In the process of fabricating the display panel provided in this embodiment, the second via 132 can be formed in the insulating layer 130 using an etching process. The second via 132 penetrates through the insulating layer 130, and corresponds to the common electrode 105 and the auxiliary electrode 140. In the pixel electrode 106 fabricated later, the auxiliary electrode 140 is connected to the common electrode 105 via the second via 132, so that the auxiliary electrode 140 and the common electrode 105 can always maintain a same voltage, and there is no need to provide an additional electrical signal to the auxiliary electrode 140, thereby simplifying the signal of the display panel.

For the display panel provided by the embodiments of the present disclosure, in order to improve the transmittance of the display panel, the following embodiments are provided.

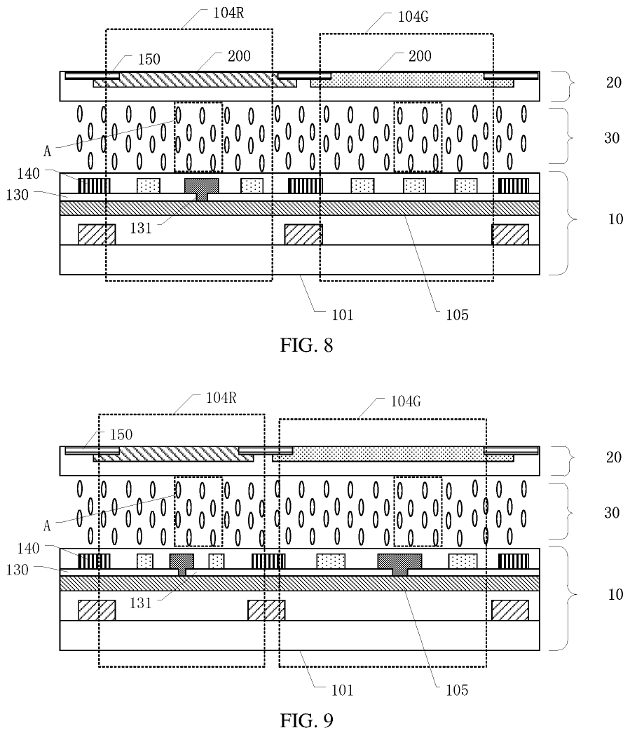

Referring to FIG. 8, FIG. 8 is a cross-sectional view of still another display panel according to an embodiment of the present disclosure. In some embodiments, the sub-pixel units 104 include a red sub-pixel unit, a blue sub-pixel unit, and a green sub-pixel unit; and the number of second strip-shaped electrodes 120 in the red sub-pixel unit 104R is greater than the number of second strip-shaped electrodes 120 in the green sub-pixel unit 104G, and/or the number of second strip-shaped electrodes 120 in the blue sub-pixel unit is greater than the number of second strip-shaped electrodes 120 in the green sub-pixel unit.

For example, in the display panel provided by this embodiment of the application, the sub-pixel units 104 include the red sub-pixel unit, the blue sub-pixel unit, and the green sub-pixel unit. Due to different materials of the color resists 200, the transmittance of the green color resist material is higher than each of the transmittance of the red color resist material and the transmittance of the blue color resist material, so the transmittance of the green sub-pixel unit is higher than each of the transmittance of the blue sub-pixel unit and the transmittance of the red sub-pixel unit. In this embodiment, the number of second strip-shaped electrodes 120 in the green sub-pixel unit is small, which can increase the transmittance of the green sub-pixel, thereby increasing the transmittance of the entire display panel. In this way, decrease in transmittance caused by the second strip-shaped electrode 120 can be balanced, thereby ensuring the display quality of the display panel.

In the display panel illustrated in FIG. 8, the number of second strip-shaped electrodes 120 in the red sub-pixel unit 104R is one, and the number of second strip-shaped electrodes 120 in the green sub-pixel unit 104G is zero. In other embodiments of the present disclosure, the number of second strip-shaped electrodes 120 in the red sub-pixel unit 104R can be two, and the number of second strip-shaped electrodes 120 in the green sub-pixel unit 104G can be one or zero. The present disclosure will not be described one by one herein.

In addition to the embodiment shown in FIG. 8, it can be set that the number of second strip-shaped electrodes 120 in the blue sub-pixel unit is greater than the number of second strip-shaped electrodes 120 in the green sub-pixel unit, or the number of the second strip-shaped electrodes 120 in the red sub-pixel unit 104R and the number of second strip-shaped electrodes 120 in the blue sub-pixel unit each are greater than the number of second strip-shaped electrodes 120 in the green sub-pixel unit 104G. The embodiment will not be described one by one herein.

Referring to FIG. 9, FIG. 9 is a cross-sectional view of still another display panel according to an embodiment of the present disclosure.

In some embodiments, the sub-pixel units 104 include a red sub-pixel unit 104R, a blue sub-pixel unit 104B, and a green sub-pixel unit 104G; an area of the green sub-pixel unit 104G is greater than an area of the red sub-pixel unit 104R, and/or an area of the green sub-pixel unit 104G is greater than an area of the blue sub-pixel unit.

For example, this embodiment can include the following three embodiments: in the first embodiment, an area of the green sub-pixel unit 104G is greater than an area of the red sub-pixel unit 104R, and an area of the green sub-pixel unit 104G can be smaller than or equal to an area of the blue sub-pixel unit; in the second embodiment, an area of the green sub-pixel unit 104G is greater than an area of the blue sub-pixel unit, and an area of the green sub-pixel unit 104G can be smaller than or equal to an area of the red sub-pixel unit 104R; in the third embodiment, an area of the green sub-pixel unit 104G is greater than an area of the red sub-pixel unit 104R, and an area of the green sub-pixel unit 104G is greater than an area of the blue sub-pixel unit.

In the display panel provided by an embodiment of the present disclosure, the sub-pixel units 104 include the red sub-pixel unit, the blue sub-pixel unit and a green sub-pixel unit. Due to the different materials of the color resists 200, the transmittance of the green color resist material is higher than each of the red color resist material and the blue color resist material, so the transmittance of the green sub-pixel unit is higher than each of the transmittance of the blue sub-pixel unit and the transmittance of the red sub-pixel unit. In an embodiment, the area of the green sub-pixel unit is relatively large, which can increase the transmittance of the green sub-pixel, thereby increasing the transmittance of the entire display panel. In this way, it can balance the decrease in transmittance caused by the second strip-shaped electrode 120, thereby ensuring the display quality of the display panel.

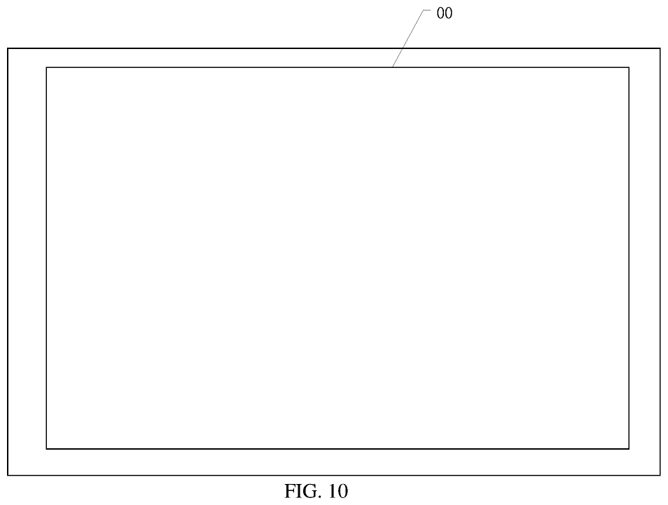

An embodiment of the present disclosure further provides a display device, including the display panel provided by any of the foregoing embodiments of the present disclosure. An embodiment of the present disclosure further provides a display device, as shown in FIG. 10, which is a schematic diagram of the display device provided by this embodiment of the present disclosure. The display device includes any of the above-mentioned display panels 00. A structure of the display panel has been described in details in the above embodiments, and will not be repeated herein. The display device shown in FIG. 10 is a vehicle-mounted display device, which is merely an example for illustration. The display device can also be any electronic device with a display function, such as a mobile phone, a tablet computer, a notebook computer, an e-book, or a television.

The display panel and the display device provided by the above-mentioned embodiments of the present disclosure have at least the following beneficial effects.

The display panel provided by the embodiment of the present disclosure includes the sub-pixel units, and for at least one sub-pixel unit of the plurality of sub-pixel units, the pixel electrodes include at least two strip-shaped electrodes, namely, at least one first strip-shaped electrode, and at least one second strip-shaped electrode.

The first strip-shaped electrode is insulated from the common electrode, and during the operation process of the display panel, the voltages of the first strip-shaped electrode and the common electrode are different from each other, and the electric field between the first strip-shaped electrode and the common electrode can control the liquid crystal molecules in the liquid crystal layer to deflect, so as to achieve the display function. The voltage of the second strip-shaped electrode is the same as the voltage of the common electrode, and there is no difference between the voltage of the second strip-shaped electrode and the voltage of the common electrode, so an electric field for controlling liquid crystal molecules to be deflected will not be formed. The liquid crystal molecules in liquid crystal layer within the region corresponding to the second strip-shaped electrode are not deflected, thereby forming the “virtual wall” structure. The liquid crystal molecules within the region corresponding to the first strip-shaped electrode will be deflected during the display process of the display panel. The liquid crystal molecules in the “virtual wall” can help the deflected liquid crystal molecules to recover to the initial state, thereby increasing the response speed of the display panel, allowing the display panel to have a good performance even in the low temperature environment. In addition, the voltage of the second strip-shaped electrode is the same as the voltage of the common electrode, that is, the voltage of the second strip-shaped electrode is constant, therefore, charge accumulation of the display panel during the operation process can be reduced, thereby alleviating image sticking. The display panel provided by the embodiment of the present disclosure can improve the user experience, and reliability and safety of the vehicle-mounted display device.

The above-described embodiments are merely some embodiments of the present disclosure and are not intended to limit the present disclosure. Any modifications, equivalent substitutions and improvements made within the principle of the present disclosure shall fall into the protection scope of the present disclosure.

1. A display panel, comprising:
a first substrate;
a second substrate opposite to the first substrate;
a liquid crystal layer sealed between the first substrate and the second substrate; and
an auxiliary electrode,
wherein the first substrate comprises:
a base substrate;
data lines;
scanning lines, wherein the data lines and the scanning lines are located on the base substrate and intersect to define sub-pixel units, and each of the sub-pixel units comprises a common electrode and a pixel electrode that are arranged in different layers;
wherein the auxiliary electrode is located between two adjacent sub-pixel units of the sub-pixel units, and the auxiliary electrode and the common electrode have a same voltage; and
wherein for each of at least one of the sub-pixel units, the pixel electrode comprises at least two strip-shaped electrodes, and the at least two strip-shaped electrodes comprise at least one first strip-shaped electrode and at least one second strip-shaped electrode; and the at least one first strip-shaped electrode is insulated from the common electrode, and the at least one second strip-shaped electrode and the common electrode have a same voltage.

2. The display panel according to claim 1, wherein a number of the at least one first strip-shaped electrode is greater than a number of the at least one second strip-shaped electrode.

3. The display panel according to claim 2, wherein the at least one first strip-shaped electrode comprises at least two first strip-shaped electrodes, and one of the at least one second strip-shaped electrode is located between two first strip-shaped electrodes of the at least two first strip-shaped electrodes.

4. The display panel according to claim 1, wherein an insulating layer is provided between the pixel electrode and the common electrode, the insulating layer is provided with at least one first via, and one of the at least one second strip-shaped electrode is electrically connected to the common electrode through one of the at least one first via.

5. The display panel according to claim 1, wherein each of the sub-pixel units is a dual-domain structure, and the dual-domain structure comprises a first domain region and a second domain region;
each of the at least two strip-shaped electrodes comprises a first sub-portion located in the first domain region and a second sub-portion located in the second domain region, and the first sub-portion extends in a direction intersecting a direction along which the second sub-portion extends; and
the first sub-portions of the at least two strip-shaped electrodes in the first domain region are parallel to each other, and the second sub-portions of the at least two strip-shaped electrodes in the second domain region are parallel to each other.

6. (canceled)

7. The display panel according to claim 1, wherein the auxiliary electrode and the pixel electrode are made of a same material and disposed in a same layer.

8. The display panel according to claim 1, wherein the first substrate or the second substrate is provided with a black matrix, and the black matrix is located at a side of the pixel electrode facing away from the base substrate; and
a vertical projection of the auxiliary electrode on the base substrate is located in a vertical projection of the black matrix on the base substrate.

9. The display panel according to claim 1, wherein an insulating layer is provided between the pixel electrode and the common electrode, the insulating layer is provided with at least one second via, and the auxiliary electrode is electrically connected to the common electrode through one of the at least one second via.

10. The display panel according to claim 1, wherein the sub-pixel units comprise a red sub-pixel unit, a blue sub-pixel unit, and a green sub-pixel unit;
a number of the at least one second strip-shaped electrode in the red sub-pixel unit is greater than a number of the at least one second strip-shaped electrode in the green sub-pixel unit, and/or
a number of the at least one second strip-shaped electrode in the blue sub-pixel unit is greater than a number of the at least one second strip-shaped electrode in the green sub-pixel unit.

11. The display panel according to claim 1, wherein the sub-pixel units comprise a red sub-pixel unit, a blue sub-pixel unit, and a green sub-pixel unit;
an area of the green sub-pixel unit is larger than an area of the red sub-pixel unit, and/or an area of the green sub-pixel unit is larger than an area of the blue sub-pixel unit.

12. A display device, comprising a display panel,
wherein the display panel comprises:
a first substrate;
a second substrate opposite to the first substrate;
a liquid crystal layer sealed between the first substrate and the second substrate; and
an auxiliary electrode,
wherein the first substrate comprises:
a base substrate;
data lines;
scanning lines, wherein the data lines and the scanning lines are located on the base substrate and intersect to define sub-pixel units, and each of the sub-pixel units comprises a common electrode and a pixel electrode that are arranged in different layers;
wherein the auxiliary electrode is located between two adjacent sub-pixel units of the sub-pixel units, wherein the auxiliary electrode and the common electrode have a same voltage; and
wherein for each of at least one of the sub-pixel units, the pixel electrode comprises at least two strip-shaped electrodes, and the at least two strip-shaped electrodes comprise at least one first strip-shaped electrode and at least one second strip-shaped electrode; and the at least one first strip-shaped electrode is insulated from the common electrode, and the at least one second strip-shaped electrode and the common electrode have a same voltage.

13. The display device according to claim 12, wherein a number of the at least one first strip-shaped electrode is greater than a number of the at least one second strip-shaped electrode.

14. The display device according to claim 13, wherein the at least one first strip-shaped electrode comprises at least two first strip-shaped electrodes, and one of the at least one second strip-shaped electrode is located between two first strip-shaped electrodes of the at least two first strip-shaped electrodes.

15. The display device according to claim 12, wherein an insulating layer is provided between the pixel electrode and the common electrode, the insulating layer is provided with at least one first via, and one of the at least one second strip-shaped electrode is electrically connected to the common electrode through one of the at least one first via.

16. The display device according to claim 12, wherein each of the sub-pixel units is a dual-domain structure, and the dual-domain structure comprises a first domain region and a second domain region;
each of the at least two strip-shaped electrodes comprises a first sub-portion located in the first domain region and a second sub-portion located in the second domain region, and the first sub-portion extends in a direction intersecting a direction along which the second sub-portion extends; and
the first sub-portions of the at least two strip-shaped electrodes in the first domain region are parallel to each other, and the second sub-portions of the at least two strip-shaped electrodes in the second domain region are parallel to each other.

17. The display device according to claim 12, wherein the auxiliary electrode and the pixel electrode are made of a same material and disposed in a same layer.

18. The display device according to claim 12, wherein the first substrate or the second substrate is provided with a black matrix, and the black matrix is located at a side of the pixel electrode facing away from the base substrate; and
a vertical projection of the auxiliary electrode on the base substrate is located in a vertical projection of the black matrix on the base substrate.

19. The display device according to claim 12, wherein an insulating layer is provided between the pixel electrode and the common electrode, the insulating layer is provided with at least one second via, and the auxiliary electrode is electrically connected to the common electrode through one of the at least one second via.

20. The display device according to claim 12, wherein the sub-pixel units comprise a red sub-pixel unit, a blue sub-pixel unit, and a green sub-pixel unit;
a number of the at least one second strip-shaped electrode in the red sub-pixel unit is greater than a number of the at least one second strip-shaped electrode in the green sub-pixel unit, and/or
a number of the at least one second strip-shaped electrode in the blue sub-pixel unit is greater than a number of the at least one second strip-shaped electrode in the green sub-pixel unit.

21. The display device according to claim 12, wherein the sub-pixel units comprise a red sub-pixel unit, a blue sub-pixel unit, and a green sub-pixel unit;
an area of the green sub-pixel unit is larger than an area of the red sub-pixel unit, and/or an area of the green sub-pixel unit is larger than an area of the blue sub-pixel unit.
